(19) United States
(12) Patent Application Publication
(10) Pub. No.: US 2006/0058139 A1
(43) Pub. Date: Mar. 16, 2006

(54) Sprocket guard and guide ring for bicycle cranks

(75) Inventor: Timothy A. Fry, Grand Junction, CO (US)

Correspondence Address: KREMBLAS, FOSTER, PHILLIPS & POLLICK, 7632 SLATE RIDGE BOULEVARD, REYNOLDSBURG, OH, 43068, US

(73) Assignee: Eko Sport, Inc.

(21) Appl. No.: 11/227,405

(22) Filed: Sep. 15, 2005

Related U.S. Application Data
(60) Provisional application No. 60/610,425, filed on Sep. 16, 2004.

(51) Int. Cl. B62J 13/00; F16H 57/02; F16D 1/00

(52) U.S. Cl. 474/144

(57) ABSTRACT

A bicycle sprocket guard that includes an inner ring and an outer ring. The guard is a pair of rings mounted together and attached to the sprocket, preferably by sandwiching the crank plate between the sprocket and the guard rings. The outer ring has low elongation, such as with a polycarbonate, to avoid interfering with the chain upon impact with hard objects. The inner ring is strong to resist deformation and absorb shock impacts from the outer ring. The inner ring will not crack under the concentrated forces at the fasteners, nor will the outer ring deform to interfere with the chain when impacting hard surfaces.

### (e) BACKGROUND OF THE INVENTION

1. Field of the Invention

The invention relates generally to devices that attach to a bicycle crank in order to prevent damage to the teeth of the front sprocket resulting from underside impacts with rocks and other obstacles while also preventing the chain from derailing from the sprocket in the outboard direction.

2. Description of the Related Art

The drivetrain of a bicycle is subjected to extreme conditions during the sport of downhill bicycle racing or when the bicycle is used for stunts and jumps or when it is used to surmount or descend unfriendly surfaces such as boulders, logs, stairs and the like. Such extreme uses pose the risk of bending the front sprocket or breaking or abrading the sprocket teeth due to underside contact with obstacles. Additionally, such activities subject the chain to rapid shaking, often simultaneously with the application of force to the pedals by the rider, entailing the risk of derailing the chain from the front sprocket in either the inboard or outboard direction.

To minimize the chance of breakage or failure of the forward part of the bicycle drivetrain during the above-described activities, rims or guide rings made of metal or resin have been affixed to the bicycle crank parallel with the front sprocket by means of the sprocket mounting holes in the crank, either on the outboard side only or on both the outboard and inboard sides of the sprocket. These guide rings are conventionally of a diameter exceeding that of the tops of the sprocket teeth and are positioned laterally far enough from the sprocket to allow clearance for the chain while being close enough to guide the chain back onto the sprocket if violent shaking of the bike and consequent whipping motion of the chain begins to derail it.

Guide rings are most commonly made of aluminum, in order to minimize weight while maximizing strength. However, aluminum rings have disadvantages for particular applications. Riders doing certain types of freestyle riding balance the weight of the bicycle on the guide ring as the bicycle slides down stairway handrails or other relatively straight and smooth inclined surfaces. Aluminum, being a poor bearing material, is less than ideal for this sliding or “grinding” action. Also, since aluminum has a relatively high elongation, under sufficient impact and depending on material thickness it may bend toward the chain or form burrs that interfere thereafter with engagement of the chain on the sprocket. Lastly, aluminum rings have a bulky, metallic look that some riders find visually unappealing.

Guide rings made of polycarbonate or other polymeric resins have the advantage of sliding easily on metal or smooth stone. Their low elongation, in combination with their other physical characteristics, prevents the kind of deformation that can result in interference with the sprocket and chain. Depending on the particular resin, it is possible to manufacture rings that are transparent or translucent and therefore have a more aesthetically pleasing appearance than those made of metal. The disadvantage of resin guide rings is their tendency, during hard vertical impacts, to develop radial cracks at the holes by which they are mounted to the bicycle cranks with screw-type fasteners.

The need therefore exists for a sprocket guard and guide ring that has a resin outer surface for sliding along hard edges, yet attaches to the bicycle crank in such a way that vertical impacts do not concentrate stresses at fastener holes in the resin material.

### (f) BRIEF SUMMARY OF THE INVENTION

The invention in its preferred embodiment consists of an inner ring of aluminum or other metal with projections extending radially inward, such projections containing holes by which the ring may be fastened to a bicycle crank in the conventional manner. A secondary ring of moldable resin is overmolded to the outer rim of the aluminum inner ring, forming a single guide ring of both resin and aluminum. Because the resin component is attached continuously along the outer diameter of the metallic inner ring, the force of vertically directed impacts is absorbed by a much larger surface area of resin than it would be if the entire guide ring were made of resin and were attached to the crank's sprocket mounting holes with fasteners.

The present invention has impact-resistance comparable to an all-metal guide ring combined with deformation-resistance and ability to slide on hard, smooth surfaces that until now has been available only with less impact-resistant all-resin guide rings.

Embodiments of the present invention, other than the one herein described, are possible with a different choice of materials. The inner ring, rather than being made of metal, might consist of a material of comparable strength such as carbon fiber composite. The outer ring, rather than being molded directly to the inner ring, could be a laminate assembly that secures the inner ring at its center between two or more components joined by glue or by fasteners such as screws or rivets. The outer ring, in addition to being made of any of various moldable resins, might consist of other composites capable of being machined, thermally formed or laid into a mold-like fixture, such as phenolic or glass fiber- or carbon fiber-reinforced cold-setting resin.

### (g) BRIEF DESCRIPTION OF THE SEVERAL VIEWS OF THE DRAWINGS

FIG. 1 is an isometric view illustrating the present invention mounted to a bicycle crank with sprocket and chain.

FIG. 2 is an exploded isometric view illustrating the present invention showing the means of attachment to a bicycle crank.

FIG. 3 is a right side and section view illustrating the invention, where the reference for orientation (front, back, right side, left side) is the bicycle.

FIG. 4 is a section view illustrating the invention and bicycle crank assembly looking forward from the midline of the bicycle bottom bracket.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose. For example, the word connected or term similar thereto are often used. They are not limited to direct connection, but include connection through other elements where such connection is recognized as being equivalent by those skilled in the art.

### (h) DETAILED DESCRIPTION OF THE INVENTION

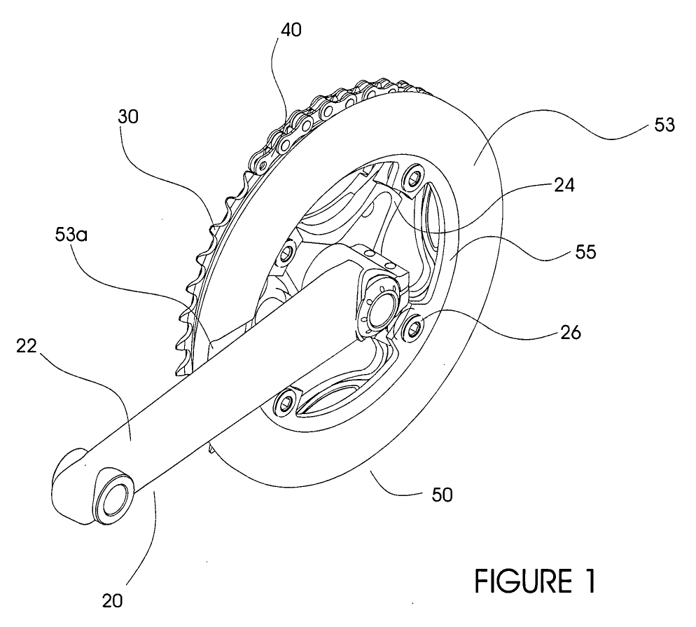

The preferred embodiment of the present invention, hereinafter called the guide ring 50, is shown in FIG. 1 attached to the bicycle crank 20. The crank arm 22 extends from a crank plate 24 with radially extending arms (“spider”). By means of the threaded fasteners 26 the sprocket 30 is attached to the crank plate 24. Drivingly engaged with the sprocket 30 is the chain 40. The guide ring 50 contains the inner metallic ring 55, which is fixed to the outboard side of the legs of the crank plate 24.

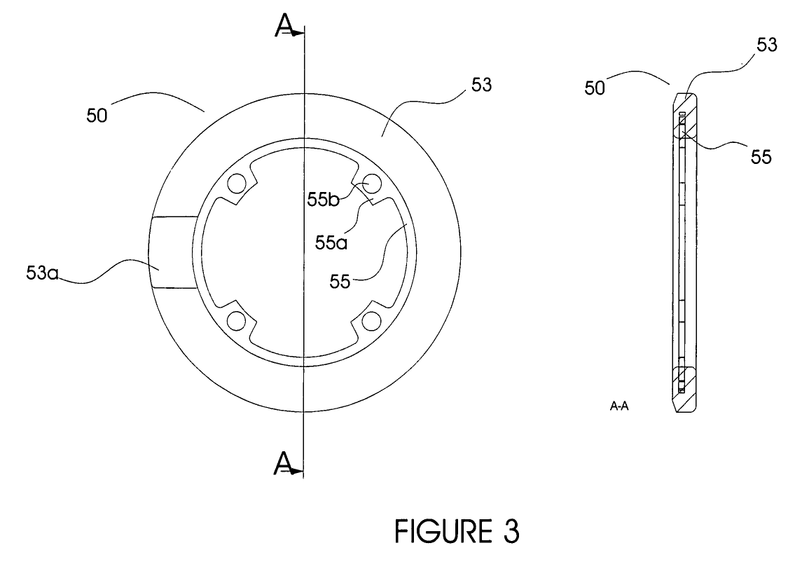

Still referring to FIG. 1, the diameter of the outer resin ring 53 of the guide ring 50 is of a diameter equal to or greater than the diameter of the sprocket 30 and chain 40 in order to protect the sprocket and chain from impacts with obstacles. The outer ring 53 is of sufficient thickness to provide a high degree of resistance to damage and the relief 53a (see FIG. 3) in the outer ring 53 accommodates the arm 22 of the crank. The relief 53a prevents interference with the bicycle crank arm 22 regardless of the thickness of the outer ring 53.

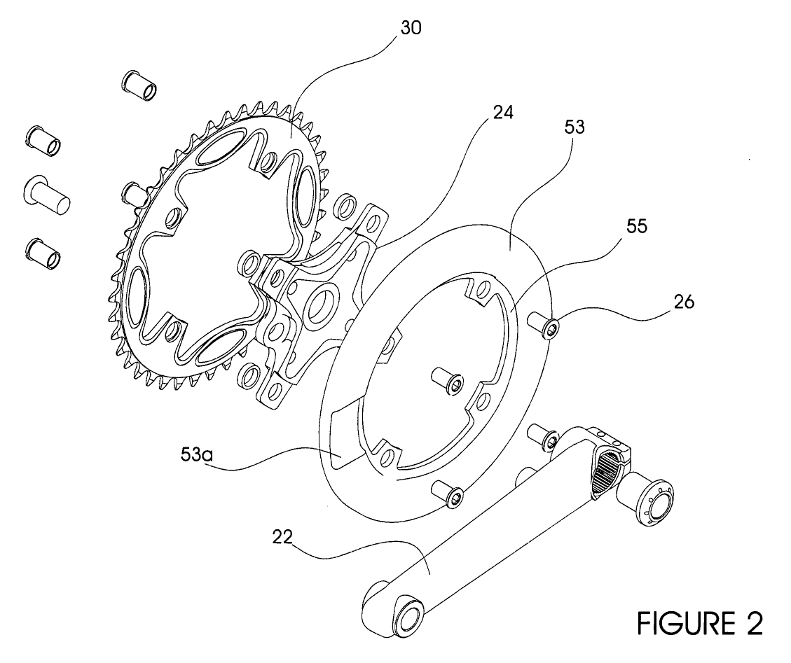

Referring to FIG. 2, the guide ring 50 with the relief 53a to prevent interference with the crank arm 22 is secured by means of the fasteners 26 that also secure the sprocket 30 to the inboard side of the crank plate 24, so that the crank plate 24 is sandwiched between the guide ring 50 and the sprocket 30. Of course, any means for attaching the guide ring 50 to the sprocket 30 can be used, as will be recognized by a person of ordinary skill, including screws, clamps, rivets and the like.

Referring to FIG. 3, the outer resin ring 53 of the guide ring 50 is overmolded or otherwise joined to the metallic inner ring 55. Some alternative means for joining the outer ring 53 to the inner ring 55 include fasteners, such as screws or rivets, adhesive and sandwiching two halves of the outer ring around the inner ring and connecting the two halves. Inward radial extensions 55a of the inner ring 55 contain the mounting holes 55b through which the fasteners 26 extend.

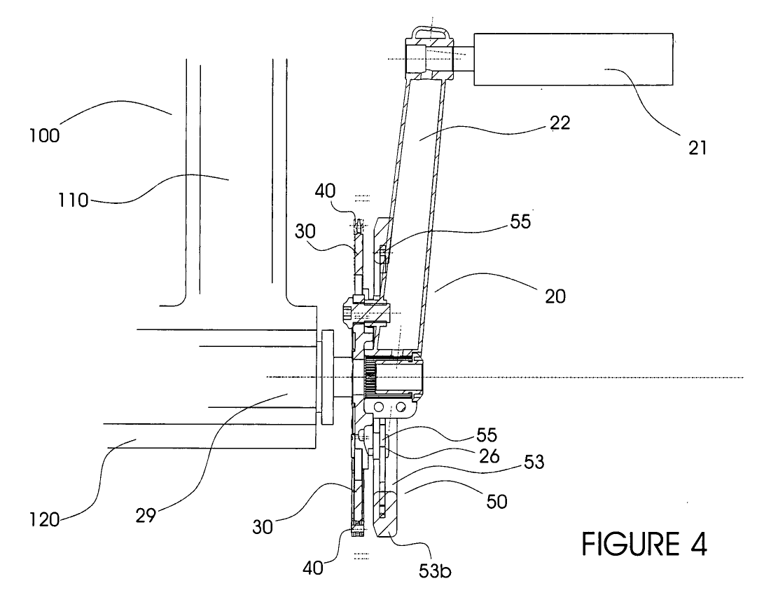

Referring to FIG. 4, the crank 20 is rotatably attached to the bicycle frame 100 by means of a spindle and bearing assembly 29 of conventional design. The spindle and bearing assembly 29 is contained within the bottom bracket shell 120, which extends to the bicycle seat tube 110 of the frame 100. The bicycle pedal 21 is attached to the crank arm 22 at its extremity. The inner ring 55 of the guide ring 50 is fixed to the crank by the fasteners 26 at a distance outboard of the sprocket 30 sufficient to allow clearance between the outer ring 53 and the chain 40. It can be seen from the section 53b of the outer ring 53 that the gap between the outboard surface of the sprocket 30 and the inboard surface of the outer ring 53 is too small to allow for derailment of the chain into the space between the sprocket 30 and outer ring 53.

While certain preferred embodiments of the present invention have been disclosed in detail, it is to be understood that various modifications may be adopted without departing from the spirit of the invention or scope of the following claims.

1. A sprocket guard for a bicycle having a sprocket with radially extending teeth for engaging a bicycle chain, the guard comprising:
(a) an inner ring having means for mounting to the sprocket, the inner ring being made of a first material; and
(b) an outer ring mounted to the inner ring for transferring, to the inner ring, any forces applied to the outer ring, the outer ring extending radially outwardly from the first ring at least as far as a radially extreme edge of the sprocket teeth, the outer ring being made of a second material that has a lower elongation than the first material.

2. The sprocket guard in accordance with claim 1, wherein a crank plate having radially outwardly extending legs is sandwiched between the sprocket and the inner ring.

3. The sprocket guard in accordance with claim 2, further comprising a relief cavity formed in the outer ring to accommodate a bicycle crank arm.

4. The sprocket guard in accordance with claim 3, wherein the inner ring is aluminum and the outer ring is a polymer resin.

5. The sprocket guard in accordance with claim 1, wherein the outer ring is molded around the peripheral edge of the inner ring.

6. A sprocket guard for a bicycle having a sprocket and a crank plate mounted to the sprocket, the sprocket having radially extending teeth for engaging a bicycle chain, the guard comprising:
(a) a metal inner ring mounted to the sprocket;
(b) a moldable resin outer ring attached to the inner ring around a peripheral edge of the inner ring for transferring, to the inner ring, any forces due to impacts to the outer ring, the outer ring extending radially outwardly from the first ring at least as far as the radial extreme of the teeth on the sprocket.

7. The sprocket guard in accordance with claim 6, wherein the crank plate is sandwiched between the sprocket and the inner ring.

8. The sprocket guard in accordance with claim 7, further comprising a relief cavity formed in the outer ring to accommodate a bicycle crank arm.

9. The sprocket guard in accordance with claim 7, wherein the inner ring has extensions extending radially inwardly, and the extensions have apertures through which fasteners extend between the sprocket and the crank plate.

10. The sprocket guard in accordance with claim 7, wherein the inner ring is aluminum and the outer ring is polycarbonate.

11. The sprocket guard in accordance with claim 7, wherein the outer ring is attached to the inner ring continuously along the peripheral edge of the inner ring.

12. The sprocket guard in accordance with claim 7, wherein the outer ring is a fiber-reinforced composite.

13. The sprocket guard in accordance with claim 1 1, wherein a gap between the sprocket and the ring is smaller than a chain width.
